(19) United States
(12) Patent Application Publication
(10) Pub. No.: US 2017/0095989 A1
(43) Pub. Date: Apr. 6, 2017

(54) SHOPPING BAG CLOSING SYSTEM

(71) Applicant: TECHNOSOLUTIONS ASSESSORIA LTDA., Barueri (BR)

(72) Inventor: Wilson Andrade Paduan, Sao Paulo (BR)

(21) Appl. No.: 15/286,883

(22) Filed: Oct. 6, 2016

(30) Foreign Application Priority Data
Oct. 6, 2015 (BR) 1020150255039

(51) Int. Cl. B31B 1/86; B65D 33/00

(52) U.S. Cl. CPC B31B 1/86; B65D 33/001; B31B 2219/23; B31B 2219/9096; B31B 2237/00

(57) ABSTRACT

The instant invention relates to a device for the application of adhesives directly on the structure of bags and shopping bags manufactured in automatic machines for packaging conformation, allowing the application liners or coating adhesive strips during the production process of the shopping bag itself.

### CROSS REFERENCE TO RELATED APPLICATIONS

This application claims priority under 35 U.S.C. §119 to the following Brazilian Patent application no. BR1020150255039, filed on Oct. 6, 2015, the contents of which are incorporated herein by reference thereto.

### BACKGROUND

The instant invention relates to a device for the authomatic application of adhesives during the production process of bags and shopping bags in specific machines This application occurs in line, without the need for an extra step exclusive to this purpose.

The production process of shopping bags, in particular the ones made of paper or cellulosic material, involves several steps, namely: 1) formation of a tube from a roll of flat material; 2) folds for the conformation of the shopping bag; 3) application of a reinforcement on the bottom of the shopping bag; 4) production of the handle reinforcement, and 5) application of the handle reinforcement.

Not all the steps need to be necessarily present and vary according to the need. Almost all of them involve the use of adhesives to provide the shape and rigidity required for the use of this type of packaging.

An example of automatic machine performing this process is described in patent document No. U.S. Pat. No. 4,915,679, by T. Gotou, the entire contents of which are incorporated herein by reference thereto.

A characteristic of this sort of manufacturing is that, in order to meet the market or customers' requirements, or also specific marketing campaigns, bags, shopping bags and packagings are produced with very individualized shapes and characters. The industry also ends up by meeting these demands in an individual manner, through the intensive use of labor that—in many cases, is temporary, which leads to low-skilled and little-experienced professionals in the field, performing this step of the production process. This problem is addressed, for instance, in document No. US20110091671A1, by M. G. Goldberg, also towards a further automation of the manufacture of packagings. The entire contents of U.S. Patent Publication No. US20110091671A1 are incorporated herein by reference thereto.

One of these situations requiring wide use of temporary labor occur when a packaging with repeated opening and closing system is needed.

A solution currently used is the application of a strip or adhesive band at the opening of the shopping bag to provide the intended effect. This application takes place after the complete conformation of the packaging, in a subsequent manufacturing step, with all the difficulties deriving therefrom, such as the organization of an extraordinary production line, personnel displacement, allocation of industrial space or, when this is infeasible, it is necessary to organize this line in another facility, with extra costs and time involved in the transportation. Moreover, matters such as the efficiency drop due to the mistakes related to the fact that production occurs in exceptional conditions must be kept in mind/

All these factors negatively affect the operation of the packaging manufacturer and are reflected in the increase of the final cost.

### SUMMARY

A shopping bag closing system, characterized in that it involves applying an adhesive on the handle reinforcement system, followed by sealing thereof by overlaying the protective tape on the adhesive in order to prevent it from sticking on the opposite inner surface of the shopping bag, wherein it can be made of silicone or plastic.

In addition to one or more of the features described above, or as an alternative to any of the foregoing embodiments wherein the shopping bag closing application system includes a hot-melt self-adhesive application apparatus, followed by the application of protective tape by the protection tape unwinder device.

In addition to one or more of the features described above, or as an alternative to any of the foregoing embodiments, wherein the shopping bag closing application system further comprises a self-adhesive application apparatus which dries by evaporating a diluent this being an aqueous or organic solvent, followed by the application of protection tape by means of a protection tape unwinder device.

In addition to one or more of the features described above, or as an alternative to any of the foregoing embodiments, wherein the shopping bag closing application system for applying self-adhesive tape, characterized in that it is directly applied on the handle reinforcement, which already contains the protection tape made of silicone or plastic, thus avoiding the need of subsequent application thereof.

In addition to one or more of the features described above, or as an alternative to any of the foregoing embodiments, wherein the shopping bag closing application system for applying self-adhesive tape, characterized in that said adhesive is stuck on the outer side of the shopping bag.

### DETAILED DESCRIPTION

The main purpose of the instant invention is that of increasing the automation of shopping bag manufacturing, in particular of those made of cellulosic material, through the implantation of a device for applying adhesive strip in the production step of the handle reinforcement.

The instant device allows the execution, still early in the manufacturing process, of a step that must currently be performed only after finalizing the packagings, with gains of productivity and reduction of losses.

Another characteristic of the proposed device is that it not only enables the application of adhesive tapes, but also of chemical adhesives, which makes the final product more versatile.

Moreover, the device allows the application of the adhesive on any of the sides of the packaging, that is, both inside and outside of the opening thereof.

The simplicity conferred to the process results from the fact that the handle reinforcement is produced through a narrow strip of paper longitudinally extending in relation to the application system, allowing continuous application by a single nozzle statically applied when hot melt or by diluent-evaporation drying glue, and a reel of protective tape or self-adhesive tape whose protection is already applied in the case of insertion of a ready tape.

A system, such as the one disclosed in document No. USUS20110091671A1, for application on the shopping bag in the transversal direction in relation to the reel direction, requires a system of multiple nozzle or mobile nozzle, which makes it difficult to apply the glue and, mainly, the protection tape.

The device allows the use of the construction system itself and the application of the handle already existing in the shopping bag machine, drastically reducing the implementation costs of the closing system.

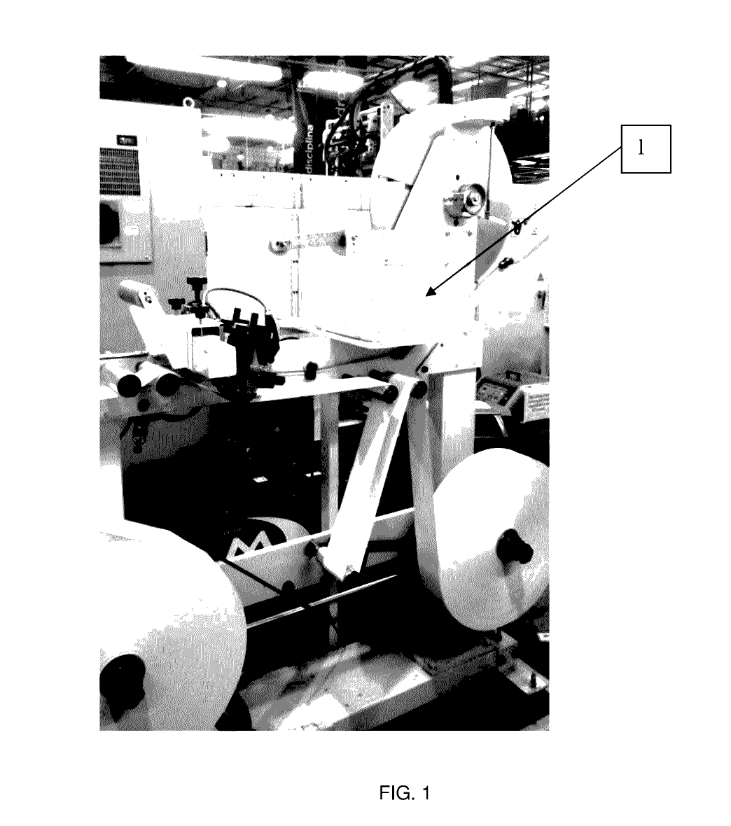

The device in operation in a shopping bag manufacturing machine is shown in FIG. 1, attached, where reference 1 shows the device for applying an adhesive on a handle reinforcement, installed in shopping bags automated machines.

The described solution expedites the automatic production of shopping bags, in particular those intended to have the closing characteristic, for instance in gifts, or those with a seal; repeated closing and opening, known as “reclosable” by persons skilled in the art; and also those in which one needs to apply any distinctive sign on the outside of the shopping bag.

What is claimed is:

1. Shopping bag closing system, characterized in that it involves applying an adhesive on the handle reinforcement system, followed by sealing thereof by overlaying the protective tape on the adhesive in order to prevent it from sticking on the opposite inner surface of the shopping bag, wherein it can be made of silicone or plastic.

2. Shopping bag closing application system for applying an adhesive on the handle system according to claim 1, characterized in that it comprises a hot-melt self-adhesive application apparatus, followed by the application of protective tape by the protection tape unwinder device.

3. Shopping bag closing application system for applying an adhesive on the handle according to claim 1, characterized in that it comprises a self-adhesive application apparatus which dries by evaporating a diluent this being an aqueous or organic solvent, followed by the application of protection tape by means of a protection tape unwinder device.

4. Shopping bag closing application system for applying self-adhesive tape, characterized in that it is directly applied on the handle reinforcement, which already contains the protection tape made of silicone or plastic, thus avoiding the need of subsequent application thereof.

5. Shopping bag closing application system according to claim 4, characterized in that said adhesive is stuck on the outer side of the shopping bag.

6. Shopping bag closing application system according to claim 1, characterized in that said adhesive is stuck on the outer side of the shopping bag.
